(19) United States
(12) Patent Application Publication
(10) Pub. No.: US 2013/0064120 A1
(43) Pub. Date: Mar. 14, 2013

(54) MEASUREMENT REPORTING IN COMMUNICATIONS SYSTEMS

(71) Applicants: Gyula Bodog, Budapest (HU); Clemens Suerbaum, Munich (DE)

(72) Inventors: Gyula Bodog, Budapest (HU); Clemens Suerbaum, Munich (DE)

(73) Assignee: NOKIA SIEMENS NETWORKS OY, Espoo (FI)

(21) Appl. No.: 13/638,357

(22) PCT Filed: Apr. 1, 2010
(86) PCT No.: PCT/EP10/54420

§ 371 Date: Sep. 28, 2012

(30) Foreign Application Priority Data
Mar. 31, 2009 (GB) 0905502.1

(51) Int. Cl. H04W 24/10

(52) U.S. Cl. 370/252

(57) ABSTRACT

A communications system comprises a managing entity responsible for handling measurement reports and a network node, the managing entity being capable of sending condition-related parameters to the network node and the network node being capable of controlling measurement reporting in a communications system by: receiving a measurement report from a mobile terminal; determining from the measurement report whether it is a type of measurement report for which condition-related parameters need to be applies; wherein if the measurement report is of the type requiring the condition-related parameters to be applied, applying a load-related condition and a security related condition and if both are satisfied, providing the measurement report to the managing entity.

This invention relates to measurement reporting in communications systems. It is particularly, but not exclusively, related to measurement reporting in mobile communications systems such as cellular mobile communications systems.

An important aspect in network planning to provide a wireless communications system is in ensuring that a network provides the necessary coverage. This may be to provide even coverage or to provide uneven coverage, for example better coverage being provided in areas in which there is the heaviest wireless communications traffic. Coverage in this sense usually refers to the signal strength experienced by a mobile terminal in a cell. It may also refer to the reliability of intercell handover.

Although there have been considerable improvements made in network planning over the past few years enabling a planned network to have the kind of coverage which is desired, the operation of a network implemented according to such a plan may not be exactly as intended. For this reason, mobile network operators employ a procedure referred to as drive testing in which vehicles equipped with special testing equipment travel around the area covered by a mobile network and collect measurement data at different geographical locations in the form of parameters such as signal strength. This means that a mobile network operator can identify problems such as coverage holes or places where handover tends to fail and change the configuration of the network to ameliorate these problems, for example by adding base stations, or changing to beam orientation of existing base stations.

Carrying out drive testing to obtain measurement data is expensive and inconvenient both in terms of the cost of the necessary equipment and of employees' or contractors' time. Therefore, it is desired to minimise the amount of drive testing which is conducted. It has been proposed in 3GPP (3rd Generation Partnership Project) to use subscriber mobile terminals (also referred to as user equipment or UE) to provide measurement data related to quality of connection over an air interface between themselves and a radio access network (RAN) of a mobile network and to use this data in a network management system of the network in order to reduce the need to carry out drive tests. Although this may not completely eliminate the need for drive testing, it is hoped that if the majority of coverage assessments can be carried out based on measurement data obtained by the RAN in communicating with subscriber mobile terminals, there is scope for considerable cost savings. The capability to provide the necessary measurement data from subscriber mobile terminals to minimise the amount of drive testing required is referred to as minimisation of drive test (MDT) functionality.

It has been proposed to use trace functionality present within a network to gather the measurement data required for MDT. Trace functionality is able to carry out traces of two basic trace types:

i) a cell trace in which trace data is collected in one or a pre-defined list of cells; and
ii) a subscriber trace in which trace data is collected for a particular mobile terminal irrespective of which cell it has moved to.

Carrying out measurements for the purposes of MDT is generally for the purposes of determining coverage in a particular geographical area, for example a cell or a group of cells, and it has been proposed to use a cell trace to gather the measurement data required for MDT. To do this, a command to carry out trace activation is sent to a suitable entity in the RAN such as a functionality controlling radio resource management of base station-type network elements which determines the mobile terminals present in a cell and then actinates selected mobile terminals to carry out MDT measurements and provide MDT measurement data to the entity which can then provide this data to higher hierarchical levels for processing to produce results relating to geographical determination of coverage.

It will be understood that a cell trace is transformed into a number of individual activation commands, each of which is received, and accepted, by relevant mobile terminals. The mobility of a mobile terminal carrying out MDT measurements can be a significant factor in controlling the way that MDT measurements are carried out. A mobile terminal instructed to provide measurement data may not have an opportunity to send this data from a cell in which it is measured and may instead send it from a cell into which the mobile terminal subsequently moves. Since MDT measurements can generate substantial amounts of data, transmission of MDT measurement data from mobile terminals may cause unexpected load in cells. If such cells are on the borderline of being overloaded, this may have an adverse impact on their operation.

According to a first aspect of the invention there is provided a method of controlling measurement reporting in a communications system comprising the steps of:

receiving a measurement report at a network node;
determining from the measurement report whether a condition-related parameter needs to be applied; and
if the measurement report requires the condition-related parameter to be applied, applying the parameter to determine whether a condition is met to allow the measurement report to be provided to a managing entity.

The network node may measure the condition. The condition may relate to load. Alternatively, the condition may relate to the state of a network node and, in one particular embodiment of the invention whether the measurement report relates to a network node the measurement reports of which are to be provided to the managing entity. In this case, the condition may be provided to the network node.

The network node may be provided with a load-related parameter which is used to control handling of measurement reports. This load-related parameter may define a load threshold governing whether the measurement report will be sent by the network node.

The network node may be provided with a list-related parameter which is used to control handling of measurement reports. This list-related parameter may define a set of network entities in respect of which measurement reports are to be sent or a set of network entities in respect of which measurement reports are not to be sent.

Preferably, it is determined from the measurement report whether it is a type of measurement report for which the condition-related parameter needs to be applied.

The managing entity may be an operations, administration, and maintenance (OAM) function. The managing entity may be provided with a sub-entity to handle measurement reports. The sub-entity may cooperate with a function in the network node which is responsible for handling measurement reports. The managing entity may be able to instruct network nodes to request mobile terminals in areas under their control to provide measurement reports.

The sub-entity may be configured to send the load-related parameter to the function in the network node so that it can control measurement reporting according to the load-related parameter and actual measured load.

The sub-entity may be configured to send the list-related parameter to the function in the network node so that it can control measurement reporting according to identification of network nodes, or cells for which the network node is responsible.

One or both of the parameters may be configured in the network node by using configuration management (CM) IRP functionality. This may involve an NM layer making a request to the EM layer. It may be a request between a manager entity and an agent entity.

A network node may have a default setting in which it is not configured with either or both of the parameters and accordingly a measurement report is to be provided to the managing entity.

A network node may apply both the load-related parameter and the list-related parameter. It may apply them in order. It may firstly carry out a load-related check based on the load-related parameter, and if this indicates that reporting of measurement reports is currently permitted according to prenailing load conditions, it may secondly carry out a list-related check in respect of the measurement report to determine whether it relates to an entry on a list.

The network node may periodically measure actual load so that this information is available for a load-related check to be performed if necessary. In an alternative embodiment, actual load is measured and checked every time a measurement report is received.

In the event that actual load exceeds the load-related parameter, the network element may broadcast a measurement report deactivation command to all mobile terminals for which it is providing service in order to deactivate their sending of measurement reports. Subsequent to this, the network node may discard any measurement reports it receives. If, subsequent to broadcasting the measurement report deactivation command, the network node receives a measurement report, it may broadcast another measurement report deactivation command.

In the event that actual load does not exceed the load-related parameter, the network element may carry out a list-related check. The list-related check may determine whether a measurement report is made in respect of a network node, or an area served by a network node, for which sending of measurement reports is permitted. If the list-related check determine that a measurement report is made in respect of a network node, or an area served by a network node, for which sending of measurement reports is not permitted, the network node may discard the measurement report without sending it to the managing entity.

The measurement report may relate to an area previously occupied by a mobile terminal but may be sent from an area now occupied by the mobile terminal. The network node may determine the area to which the measurement report relates and may check whether this area corresponds to an entry on the list-related parameter. If this is the case, the network node may provide the measurement report to the managing entity. This may apply even if the list-related parameter does not have an entry relating to the network node handling the measurement report. If it is not the case that this area corresponds to an entry on the list-related parameter, the network node may discard the measurement report without sending it to the managing entity. This may apply even the list-related parameter does have an entry relating to the network node handling the measurement report.

Preferably, a processed form of the measurement report is sent. This may be the measurement report with information added or information taken away. It may be a collection of measurement reports.

The measurement reports may be provided by mobile terminals. A mobile terminal may receive an instruction configuring it to provide measurement data in the form of measurement reports. The measurement data may relate to MDT.

The measurement report may relate to the determination of coverage in a particular geographical area, for example a cell or a group of cells. Geographical determination of coverage may be determined by a network management system as a result of receiving measurement reports.

The network node may be an entity in the RAN of a system. The managing entity may be at a higher hierarchical level. However, it will be understood that according to the invention, decision-making relating to sending or not sending the measurement report occurs in the network node, for example in an NE layer.

Preferably, the managing entity controls the network node. It may be responsible for OAM management of the network node. The managing entity may be the whole of or part of a management system of the network. The management system may control both OAM and MDT aspects of the network. Functionalities responsible for both of these aspects may be in a management system but separate from each other.

According to a second aspect of the invention there is provided a network node capable of controlling measurement reporting in a communications system, the network node comprising:

a receiving block capable of receiving a measurement report at a network node;
a checking block capable of determining from the measurement report whether a condition-related parameter needs to be applied; and
a detector,
wherein if the checking block indicates that measurement report requires the condition-related parameter to be applied, the detector applies the parameter to determine whether a condition is met to determine to allow the measurement report to be provided to a managing entity.

The node may also comprise a sending block capable of sending the measurement report to the managing entity.

According to a third aspect of the invention there is provided a network management system capable of configuring a network node with a condition-related parameter in order to control measurement reporting in a communications system, the network management system comprising a sending block capable of sending the condition-related parameter to the network node and configuring the network node so that on receiving a measurement report, the network node is able to determine from the measurement report whether the condition-related parameter needs to be applied, and if so, the network node applies the condition-related parameter to determine whether a condition is met to allow the measurement report to be provided to the network management system.

The network management system may also comprise a receiving block capable of receiving the measurement report from the network node.

According to a fourth aspect of the invention there is provided a communications system comprising a managing entity and a network node, the managing entity being capable of sending a condition-related parameter to the network node and the network node being capable of controlling measurement reporting, the network node comprising:

a receiving block capable of receiving a measurement report at a network node;
a checking block capable of determining from the measurement report whether a condition-related parameter needs to be applied; and
a detector,
wherein if the checking block indicates that the measurement report requires the condition-related parameter to be applied, the detector applies the parameter to determine whether a condition is met to allow the measurement report to be provided to the managing entity.

According to a fifth aspect of the invention there is provided a computer program product comprising software code that when executed on a computing system performs a method of controlling measurement reporting in a communications system comprising the steps of:

receiving a measurement report at a network node;
determining from the measurement report whether a condition-related parameter needs to be applied;
if the measurement report requires the condition-related parameter to be applied, applying the parameter to determine whether a condition is met to allow the measurement report to be provided to a managing entity.

Preferably, the computer program product has executable code portions which are capable of carrying out the steps of the method.

Preferably, the computer program product is stored on a computer-readable medium.

According to a sixth aspect of the invention there is provided a method of configuring a network node with a condition-related parameter in order to control measurement reporting in a communications system comprising sending the condition-related parameter to the network node and configuring the network node so that on receiving a measurement report, the network node is able to determine from the measurement report whether the condition-related parameter needs to be applied, and if so, the network node applies the condition-related parameter to determine whether a condition is met to allow the measurement report to be provided to the network management system.

The invention may relate to measurement reporting in a mobile communications system. It may relate to measurement reporting in a cellular system.

An embodiment of the invention will now be described, by way of example only, with reference to the accompanying drawings in which:

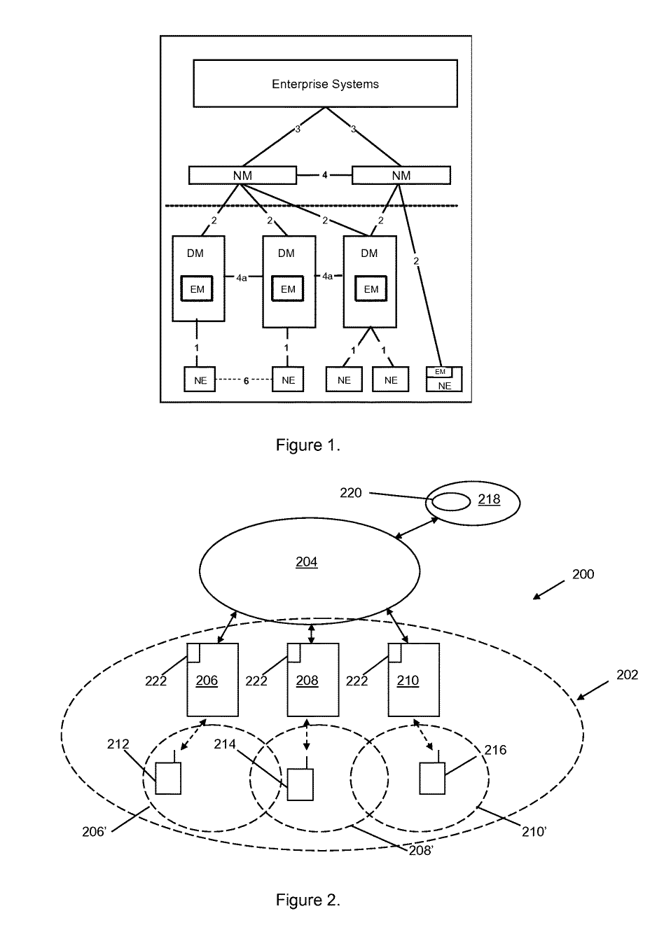

FIG. 1 shows a management architecture;

FIG. 2 shows a system according to the invention; and

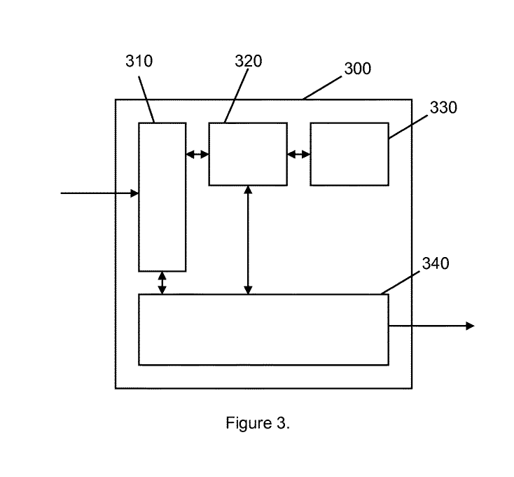

FIG. 3 shows a network node.

FIG. 1 shows a 3GPP management architecture in which the main functional blocks involved in the management of a network are presented. The architecture applies both to 3G and LTE systems. The architecture is arranged in a hierarchy having at a lowest layer discrete telecommunications entities referred to as network elements (NEs) which can be managed over a specific interface. In a 3G system, an NE may be a radio network controller (RNC). In an LTE system, an NE may be an eNB. Above the NE layer are element managers (EMs) which provide a package of end-user functions for the management of a set of closely related types of NEs. An EM can either be a functionality contained within a Domain Manager (DM) which provides element management functions and domain management functions for a sub-network or can be configured as part of an NE. The DMs (or EMs) are managed by Network Managers (NMs) which are responsible for the management of a network mainly via EMs but also possibly directly to the NEs. The NM layer communicates with the DM/EM layer over an interface referred to as a type 2 interface or Itf N. The combination of the EM layer and the NM layer is often referred to as the network management system. Finally, the NM layer communicates with Enterprise Systems which are information systems used by a network operator which are not directly related to telecommunications aspects and include functionalities such as call centres, fraud detection and prevention systems, and invoicing systems.

The Itf-N connects the network management system to EMs (located in either a DM or in an NE). This connection is made by means of Integration Reference Points (IRPs). An IRP describes the information flow and associated objects or information elements which are used to carry out functions such as network configuration. An NM is able to monitor a communications network including managing EMs over the Itf-N. This typically involves an IRP Manager in the NM layer communicating with an IRP Agent in an EM in the EM layer.

An IRP referred to as a trace IRP supports operations required for Subscriber and Equipment trace, Service Level Trace and Cell Traffic Trace functionalities.

When a cell trace is requested, an IRP Agent sends the trace activation signal to the RAN network element (eNB) indicating a list of cells where the trace is activated. After the trace has been activated, the eNB reports all data relevant to all mobile terminals operating within the cell to a trace collection entity (TCE).

In order to carry out MDT measurements based on trace functionality, an IRP Manager function in the NM layer sends a Start MDT message to an IRP Agent function in the EM layer. The Start MDT message is forwarded by the IRP Agent to an appropriate network element in the RAN, for example an eNB. The network element in the RAN communicates with the mobile terminals present in the relevant geographical area and identifies those mobile terminals which are suitable to be used to provide MDT measurement data. Once it has selected particular mobile terminals which are to be used, it configures selected mobile terminals for MDT data collection by sending a trace activation to the selected mobile terminals. As a result, a trace is activated in respect of each of the selected mobile terminals. The trace activation contains a trace reference, the IP address of the entity to which a trace log is to be sent, and possibly some additional information about MDT, for example whether it is necessary for the mobile terminal to include GPS data with the measurement data when it sends a trace log to the eNB. In response to receiving the trace activation the mobile terminal starts logging MDT measurement data and associated location information. This data and information, together with an identifier of the cell (cell ID) to which is relates, is provided in the form of an MDT report to the eNB which sends it on further so that it reaches the network management system.

Once a mobile terminal has been configured to provide MDT measurement data, subsequent mobility of the mobile terminal may cause problems. For example, if the mobile terminal moves to another area of the network, such as a different cell, the mobile terminal may continue to send MDT measurement data reports. Such reports are in addition to the normal signalling taking place between a normally operating mobile terminal and a base station and represent additional loading in a cell. If the other area is already overloaded, the additional signalling represented by the MDT measurement data reports can cause problems.

Furthermore, in the case of radio link failure (RLF) which severs the connection between a mobile terminal and the network, an MDT report will only be sent to the network when a mobile terminal re-connects to the network. This can happen in a location different to that where MDT was activated, for example in a different cell to that in which the cell trace was activated. However there can be areas in the network where load is high and a network operator may want to avoid any additional load in the network and may not want to load the network with additional mobile terminal measurement data collection.

Also sending trace activation to a mobile terminal and requesting the mobile terminal to collect data and to send collected data to the network can lead to a security risk because mobile terminals are not sufficiently under the control of a network operator such as to prevent deliberate misconfiguration of mobile terminals by users or other parties in order to cause mischief in the network.

In order to deal with these problems, in a system according to the invention, the entity controlling radio resource management of base stations, for example the relevant part of an eNB, is configured with a load-related parameter which is used to control MDT reporting by mobile terminals present in a cell or cells under its control. This load-related parameter is settable by a network operator to select a load threshold which if exceeded by the cell load will result in MDT reporting being prevented in that cell. As a result, the load-related parameter can be used to avoid unnecessary load to the network in a place in situations in which additional non-essential loading of the cell is undesirable.

Furthermore, the entity is configured with a list of cells in relation to which MDT measurements may be made.

The invention will now be described in more detail in relation to FIG. 2. FIG. 2 shows an LTE mobile communications network 200 comprising a RAN 202 and a core network 204. The RAN has a number of eNBs 206, 208, and 210 which provide radio access to mobile terminals 212, 214, and 216 present in cells 206′, 208′, and 210′, and the core network 204 has functionality to provide for call switching/routing and call control, service provision, authentication and charging, and interconnection enabling access to other networks.

In addition, an operations, administration, and maintenance (OAM) function 218 is linked to the core network and is capable of configuring and provisioning network nodes of the RAN 202 and the core network 204. It also carries out various related tasks such as collecting network statistics, alarm monitoring and logging of events. The resulting statistics, alarms and logs are used by a network operator to monitor the health and performance of the network 200. Although in this embodiment, the OAM function 218 is shown as being separate from the core network 204, in other embodiments of the invention, the OAM function 218 may be present in the core network 204. In either case, both the core network 204 and the OAM function 218 are present within the domain of the network operator and both are under its control.

Referring back briefly to FIG. 1, the eNBs and the core network are present in the NE layer, and functionalities of the OAM function 218 are present in the EM, DM, and NM layers. For example, the OAM function 218 as IRPAgent is present in the EM layer and as IRPManager is present in the NM layer. The EM layer is a distributed functionality, while the NM layer can be considered as a centralised functionality. MDT reports are forwarded to the NM layer which represents a central location at which a network operator can access necessary information.

Turning again to the invention, the OAM function 218 is provided with an MDT management entity 220. This entity 220 controls MDT operation within the network 200, for example receiving instructions to arrange for MDT measurements to be gathered in respect of a specific geographic area of the network 200 and then sending out the necessary activations to eNBs for them to activate MDT measuring in mobile terminals present in relevant locations. The MDT management entity 220 in the OAM function 218 cooperates with MDT units 222 in the eNBs which receive MDT-related commands and take appropriate action. For example, an MDT unit 222 in a particular eNB receives a command that MDT measurements are to be carried out in a particular cell, and as a result, sends individual MDT activations to suitable mobile terminals located in the cell which causes the mobile terminals to start making MDT measurements and to provide MDT reports to the eNB. The eNB sends the MDT measurements in the form they are received or collates or otherwise processes them, and then sends them to the OAM function 218 where they are processed and used to generate output data suitable for use in managing the network 200.

The MDT management entity 220 and the MDT units 222 are specifically configured to operate according to the invention. The MDT management entity 220 is able to send a load-related parameter to MDT units 222 of selected eNBs, or to activate such a parameter already present in the eNBs, so that they can control MDT reporting according to the load-related parameter and actual measured load. Furthermore, the OAM function provides to each eNB a list of approved cells (“an approved cell list”) indicating the cells in relation to which MDT reports are to be provided by mobile terminals. This list is security-related and its use is described in the following.

There are many eNBs and the OAM function 218 in the NM layer is used to configure them. This is done over the NM/EM layer interface. The NM layer makes a request to the EM layer that cells having particular identifiers are to be configured according to a particular load-related parameter. This is done by using configuration management (CM) IRP functionality. All eNBs in the network may be configured. However, in the case that only certain of the eNBs are to be provided with a load-related parameter and/or an approved cell list, other eNBs may not be so configured.

In an embodiment of the invention, the network 200 is configured so that configuration management employs a network resource model (NRM). In this approach, the model uses objects to represent actual managed telecommunication network resources, for example specific network nodes or elements. An NRM describes managed object classes, their associations, attributes, and operations. A managed object (MO) is a software object that encapsulates management characteristics and behaviour of a particular network resource. The managed object is an “instance” of a “managed object class” defined in an NRM. A managed object class has attributes that provide information used to characterise the objects that belong to the class. In addition, a managed object class can have operations that represent the behaviour relevant for that class. An instance of a managed object class is sometimes called a “managed element”.

In this embodiment of the invention, in order to implement the load-related parameter, an object which relates to network elements such as eNBs in the RAN, for example EutranGenericCell (or in an implementation in a 3G system UtranGenericCell), is arranged to contain a relevant load-related attribute. This attribute defines the cell load limit which is to apply while MDT reporting is to be accepted in the cell. If the cell load is above the limit, the eNB is to request mobile terminals in the cell to cease MDT reporting. If in a certain cell no MDT reporting is required in any circumstances, the threshold is set to 0% (so in any load circumstances the eNB does not accept any MDT reporting in that specific cell). Configuring the load-related parameter is done by carrying out a CM operation.

In order to implement the security-related list, an attribute containing a list of EutranCells (or in an implementation in a 3G system UtranCells) is included and maintained in an object class referred to as eNBFunction (or in an implementation in a 3G system RNCFunction) of the network management system. This list of cells indicates those cells to the eNB where the MDT reporting is activated so that an eNB is able to determine whether, in respect of an MDT report received from the mobile terminal (including the cell ID), the MDT report is generated from an approved cell. If the MDT report contains a cell ID which is not in the approved list, the received MDT report is rejected. Configuring the approved list is done by carrying out a CM operation.

The default setting for a cell is “MDT reporting”, that is MDT reports are to be passed on to the OAM function 218. Therefore, any cell not configured with the security-related list will automatically send the MDT reports. In this case, either the cell has a default setting of the load-related parameter of 100% or no load-parameter has been set for that cell but it operates as though it has a load-related parameter set to 100%. If a cell is configured with the security-related list, the list indicates certain cells with an appropriate identifier and, if the configured cell holding the list receives an MDT report including an identifier corresponding to one or more of those in the list, it will send the MDT report to the OAM function 218. However, if an MDT report is received including an identifier which does not correspond to one or more of those in the list, the configured cell will discard the MDT report. This can be referred to as a white list. In an alternative embodiment of the invention, the configured cell is configured with a security-related list referred to as a black list which indicates certain cells with an appropriate identifier, and if the configured cell holding the list receives an MDT report including an identifier corresponding to one or more of those in the list, it will discard the MDT report and if the identifier does not correspond to one or more of those in the list, the configured cell will send the MDT report to the OAM function 218.

The load-related parameter is settable as a value within a range from 0% to 100%, with the value representing acceptable load level. If the parameter is set to have an intermediate value, for example 50% this means that if the actual load is higher than the parameter then the consequences triggered by the parameter are to be applied and if the actual load is lower than the parameter then the consequences triggered by the parameter are not to be applied. Accordingly, it will be understood that if the parameter is set to 0%, the acceptable load level is 0% which means that the consequences triggered by the parameter are to apply in all circumstances, and if the parameter is set to 100%, the acceptable load level is 100% which means that the consequences triggered by the parameter are to apply in no circumstances.

The operation of the invention will now be described. It will be assumed that the MDT management entity has set the load-related parameter in an eNB to a particular value such as 75%. This represents that 75% of the total available amount of a particular type of resource of a cell is being used. For example, it may be indicative of a positive characteristic such as how many radio resource control (RRC) connections have been established or a negative characteristic such as how many congestion or RRC connection failures have occurred. Furthermore, it will be assumed that the OAM function 218 has instructed various eNBs to request mobile terminals in areas under their control to carry out MDT measurements within particular cells.

In understanding the operation of the invention, is useful to distinguish between two main MDT-related functionalities of mobile terminals:

1) carrying out MDT measurements; and
2) reporting MDT measurements.

In relation to 1) mobile terminals are configured to carry out MDT measurements only in a cell in relation to which the mobile terminal was instructed to carry them out. If the mobile terminal moves to another cell, it will stop making the measurements. However, since in normal operation a mobile terminal is free to report the MDT measurements, that is functionality 2) at any point in the network, if the mobile terminal was instructed to make MDT measurements in a first cell but then moves to a second cell before sending a corresponding MDT report, this second cell being a cell for which the mobile terminal has not been instructed to make MDT measurements, the mobile terminal is still able to send its MDT report from the second cell in relation to the first cell.

An illustration of the way in which 1) does not immediately and automatically lead to 2) is that MDT related measurements can be carried out by a mobile terminal when it is in idle mode, that is while it does not have an active connection to the network. In such a case the mobile terminal collects the MDT measurements referred to as an MDT log. Once the mobile terminal establishes a connection to the network, it sends collected MDT logs in one or more MDT reports. This network connection establishment may happen in a different cell to that where the mobile terminal was MDT-activated. The invention can be applied to discard or allow transmission of MDT reports collected during an idle time.

When a particular eNB receives an MDT report, it will firstly carry out a load-related check based on the load-related parameter, and if this indicates that MDT reporting is currently permitted for the cell according to prevailing load conditions, it will secondly carry out a security-related check based on the security-related list.

Accordingly, the eNB carries out the load-related check in which it periodically, for example every fifteen minutes, compares measured load, for example actual measured load measurement based on successful RRC establishments, against the load-related parameter in order to determine whether the measured load in a cell has exceeded a threshold represented by the load parameter. However, in an alternative embodiment, measured load may be checked every time an MDT report is received. The eNB also carries out a security-related check in respect of an MDT report it receives to determine whether it is in respect of a cell which is on the approved cell list.

In the event that actual load in the cell exceeds the load-related parameter threshold, the eNB firstly broadcasts an MDT-command (an MDT deactivation command) to all mobile terminals within the cell disabling their MDT reporting. Following this, if the eNB receives an MDT report, for example from a newly-arrived mobile terminal, it will discard this MDT report and then send another broadcast message disabling MDT reporting for the newly-arrived mobile terminal and for another other newly-arrived mobile terminals which have not yet sent MDT reports. The eNB will continue in this mode unless it decides that it is not overloaded or receives an indication from elsewhere that the load-related parameter is not to apply, or that n load-related parameter set to 100% is to apply.

If the actual load of the cell does not exceed the load-related parameter threshold, then the security-related check is carried out. As described in the foregoing, eNBs are configured with the information of the approved cell list and if an eNB receives from a mobile terminal within its coverage area an MDT report in respect of a cell not on the approved cell list, it discards that MDT report.

Although the load-related parameter and the approved cell list information is provided by the OAM function 218, the OAM function 218 does not carry out any actions in terms of directly controlling MDT report discarding or transmission.

The situation described in the foregoing is made more complicated by the fact that MDT reports are being provided by mobile terminals which are mobile within an environment in which MDT reports may be permitted from some locations but not from other locations.

The following relates to security-related checking Although load-related checking is also carried out as a first filter, it will be assumed that actual loads are within any load-related parameter thresholds which have been set in order to provide a straightforward explanation.

In an example case, the eNBs 206, 208, and 210 are each configured with an approved cell list which indicates that MDT reports are permitted from the cell 206′ and the cell 208′ (“MDT reporting permitted”) but not from the cell 210′ (“MDT reporting not permitted”). A mobile terminal is in the cell 206′. The mobile terminal had previously been instructed, when it was in cell 206′, to provide MDT reports and it had accepted this instruction. The mobile terminal now moves into cell 208′. It continues to provide MDT reports.

In a first possibility, in the cell 208′ an RLF occurs between the mobile terminal and the eNB 208. However, the mobile terminal is unable to report from the cell 208′ because of this failure. The mobile terminal moves back into the cell 206′ and once a connection has been re-established, the mobile terminal sends an MDT report including information about the RLF relating to the cell 208′. The MDT report is received by the eNB 206. However, this MDT report relates to the cell 208′ rather than to the cell 206′. The eNB 206 then checks to see whether the MDT report it has received relates to a cell which is on the approved cell list, that is “MDT reporting permitted”. In this case, the eNB 206 determines that the cell 208′ is on the approved cell list and the eNB 206 provides the MDT report to the OAM function 218.

In a second possibility, in the cell 208′ a radio link failure (RLF) occurs between the mobile terminal and the eNB 208. However, the mobile terminal is unable to report from the cell 208′ because of this failure. The mobile terminal then moves into the cell 210′ and once a connection has been re-established, the mobile terminal sends an MDT report including information about the RLF relating to the cell 208′. The MDT report is received by the eNB 210. However, this MDT report relates to the cell 208′ rather than to the cell 210′.

The eNB 210 then checks to see whether the MDT report it has received relates to a cell which is on the approved cell list, that is “MDT reporting permitted”. In this case, the eNB 210 determines that cell 208′ is on the approved cell list, and even though the MDT report has come from a cell which is not on the approved cell list, that is cell 210′, the eNB 210 provides the MDT report to the OAM function 218.

In a third possibility, in the cell 210′ an RLF occurs between the mobile terminal and the eNB 210. However, the mobile terminal is unable to report from the cell 210′ because of this failure. The mobile terminal then moves into the cell 206′ or the cell 208′ and once a connection has been re-established, the mobile terminal sends an MDT report including information about the RLF relating to the cell 210′. The MDT report is received by the eNB 206 or the eNB 208. However, this MDT report relates to the cell 210′ rather than to the cell 206′ or the cell 208′. The eNB 206 or the eNB 208 then checks to see whether the MDT report it has received refates to a cell which is on the approved cell list, that is “MDT reporting permitted”. In this case, the eNB 206 or the eNB 208 determines that the cell 210′ is not on the approved cell list, and therefore, the eNB 206 or the eNB 208 does not provide the MDT report to the OAM function 218 and the MDT report is discarded.

FIG. 3 shows a network node 300 according to the invention. In the implementation discussed on the foregoing, the network node is an eNB. The network node comprises a receiving block 310 capable of receiving an MDT report. This block also comprises a capability for sending message and it is the means by which the network node makes wireless connections and sends and receives messages in addition to those specific to MDT. The receiving block 310 is connected to a checking block 320 which receives a received message and determines whether it is an MDT report or a different type of message. It should be noted here that a network node may receive many different kinds of messages, some or which are measurement reports which are not MDT-related. In a situation in which a received message is an MDT report, the checking block 320 refers to a detector 330 which carries out a load-related check and a security-related check. Depending on the outcome of these checks, the checking block 320 either discards the MDT report or provides it to a general network node functionality 340 which arranges for the MDT report to be sent to the OAM function 218.

In all of the cases described in the foregoing, accepting or rejecting an MDT report occurs in the NE layer and the OAM function 218 automatically accepts the MDT report without carrying out a further check itself. The management system does not carry out any actions to directly control MDT report transmission. It either receives MDT reports or does not receive discarded reports depending on decisions made by eNBs. However the eNB/RNC may send a notification to the management system informing the management system about a rejected MDT report and the reason(s) for rejection.

In understanding the possibilities presented in the foregoing, it is useful to keep in mind the distinction between an MDT report sent from a cell (which might or might relate to the cell from which it is sent) and an MDT report sent which relates to a particular cell. The cells in question do not have to be the same.

The purpose of the security-related check is primarily to avoid the possibility of malfunctioning mobile terminals or deliberately mis-configured mobile terminals flooding the network with unwanted reports and thus overloading the network's network management system. By checking that an MDT report has come from a location from which MDT reports are to be expected will at least catch “rogue” MDT reports coming from mobile terminals in non-approved cells. This may also enable such malfunctioning or deliberately mis-configured mobile terminals to be identified and remedial action taken against them.

Accordingly, the invention enables a network operator to control a network and configure it so that mobile terminal measurement data collection is ensured only from certain cells and if needed can configure the network so that in high load areas data collection is not processed further. Restricting data collection from only certain cells helps the network operator avoid unnecessary or unwanted MDT reports being handled and processed and thus avoids flooding the network and possibly causing an overload situation.

Although in the foregoing example, the invention is implemented in an LTE system and the network nodes are eNBs, in a 3G implementation, the network nodes provided with the load-related parameter and/or the security-related list are RNCs. It should be noted that not all of the network nodes in a communications system need to be provided with the load-related parameter and/or the security-related list or indeed configured to operate according to the invention. It will be understood that the invention is not restricted to handling MDT reports but can be applied to any measurement messages sent by a mobile terminal which are not necessarily being sent in enabling a mobile communications network to provide a mobile connectivity service to mobile terminals. For example, the invention may apply to any other kind of OAM messages.

While preferred embodiments of the invention have been shown and described, it will be understood that such embodiments are described by way of example only. Numerous variations, changes and substitutions will occur to those skilled in the art without departing from the scope of the present invention. Accordingly, it is intended that the following claims cover all such variations or equivalents as fall within the spirit and the scope of the invention.

1. A method of controlling measurement reporting in a communications system comprising the steps of:
receiving a measurement report at a network node;
determining from the measurement report whether a condition-related parameter needs to be applied;
if the measurement report requires the condition-related parameter to be applied, applying the parameter to determine whether a condition is met to allow the measurement report to be provided to a managing entity.

2. A method according to claim 1 in which the condition is related to load.

3. A method according to claim 1 in which the condition is related to whether measurement reports relating to a particular network node are to be provided to the managing entity.

4. A method according to claim 1 in which the network node firstly carries out a load-related check based on a load-related parameter, and if this indicates that reporting of measurement reports is currently permitted according to prevailing load conditions, secondly carries out a list-related check in respect of the measurement report to determine whether it relates to an entry on a list.

5. A method according to claim 1 in which a check is carried out to determine whether a measurement report is made in respect of a network node, or an area served by a network node, for which sending of measurement reports is permitted.

6. A method according to claim 5 in which if the check determines that a measurement report is made in respect of a network node, or an area served by a network node, for which sending of measurement reports is not permitted, the network node discards the measurement report without sending it to the managing entity.

7. A method according to claim 1 in which in the event that measured load exceeds a defined load condition, the network element broadcasts a measurement report deactivation command to all mobile terminals for which it is providing service in order to deactivate their sending of measurement reports.

8. A method according to claim 7 in which if, subsequent to broadcasting the measurement report deactivation command, the network node receives a measurement report, it broadcasts an additional measurement report deactivation command.

9. A method according to claim 8 in which the network node discards the measurement report received after it has broadcast the measurement report deactivation command.

10. A method according to claim 1 in which the managing entity controls the network node.

11. A method according to claim 1 in which the managing entity configures the network nodes with at least one of a load-related parameter and a list-related parameter.

12. A network node capable of controlling measurement reporting in a communications system, the network node comprising:
a receiving block capable of receiving a measurement report;
a checking block capable of determining from the measurement report whether a condition-related parameter needs to be applied; and
a detector,
wherein if the checking block indicates that measurement report requires the condition-related parameter to be applied, the detector applies the parameter to determine whether a condition is met to determine to allow the measurement report to be provided to a managing entity.

13. A network management system capable of configuring a network node with a condition-related parameter in order to control measurement reporting in a communications system, the network management system comprising a sending block capable of sending the condition-related parameter to the network node and configuring the network node so that on receiving a measurement report, the network node is able to determine from the measurement report whether the condition-related parameter needs to be applied, and if so, the network node applies the condition-related parameter to determine whether a condition is met to allow the measurement report to be provided to the network management system.

14. A communications system comprising a managing entity and a network node, the managing entity being capable of sending a condition-related parameter to the network node and the network node being capable of controlling measurement reporting, the network node comprising:
a receiving block capable of receiving a measurement report at a network node;
a checking block capable of determining from the measurement report whether a condition-related parameter needs to be applied; and
a detector,
wherein if the checking block indicates that the measurement report requires the condition-related parameter to be applied, the detector applies the parameter to determine whether a condition is met to allow the measurement report to be provided to the managing entity.

15. A method of configuring a network node with a condition-related parameter in order to control measurement reporting in a communications system comprising sending the condition-related parameter to the network node and configuring the network node so that on receiving a measurement report, the network node is able to determine from the measurement report whether the condition-related parameter needs to be applied, and if so, the network node applies the condition-related parameter to determine whether a condition is met to allow the measurement report to be provided to the network management system.
